(19) United States
(12) Patent Application Publication
(10) Pub. No.: US 2025/0382502 A1
(43) Pub. Date: Dec. 18, 2025

(54) DOUBLE-SIDED ADHESIVE TAPE

(71) Applicant: Gottlieb Binder GmbH & Co. KG, Holzgerlingen (DE)

(72) Inventors: Lars Heepe, Tübingen (DE); Dirk-Michael Drotlef, Tiefenbronn (DE)

(73) Assignee: Gottlieb Binder GmbH & Co. KG, Holzgerlingen (DE)

(21) Appl. No.: 19/237,534

(22) Filed: Jun. 13, 2025

(30) Foreign Application Priority Data
Jun. 17, 2024 (DE) 102024205553.0

(51) Int. Cl. C09J 7/29

(52) U.S. Cl. CPC C09J 7/29; C09J 2301/124; C09J 2301/16; C09J 2301/204; C09J 2301/31

(57) ABSTRACT

An adhesive tape has a carrier and first and second projections, each of which is directly connected via one end to the carrier. The projections are situated on opposite carrier surfaces on the surface of the carrier. A first surface density with which the first projections are distributed on the first carrier surface is different from a second surface density with which the second projections are distributed on the second carrier surface. A further layer can be provided between layers of the carrier in order to be able to make the layers thinner while still maintaining high stability.

### CROSS-REFERENCE TO RELATED APPLICATIONS

This application claims priority to German Patent Application No. DE 10 2024 205 533.0 filed Jun. 17, 2024, the entire contents of which are hereby incorporated in full by this reference.

### DESCRIPTION

### Field of the Invention

The invention relates to an adhesive tape comprising a carrier whose surface is formed with a first carrier surface and a second carrier surface, the carrier surfaces being opposite one another.

### Background of the Invention

DE 10 2017 131 345 A1 discloses an object with two surfaces, where one surface has a different adhesion parameter to the other surface. Due to the different adhesive properties of the surfaces, the object should be able to be attached to items with varying degrees of strength and then detached from the objects again. The adhesion forces for adhering the object to items are caused by projections on the surfaces, wherein the projections of one surface differ from the projections of the other surface in terms of height, diameter and/or elastic modulus.

To achieve these differences in the projections, the projections must be manufactured under different process conditions.

Object of the invention: In contrast, it is the object of the invention to provide a double-sided adhesive tape in which adhesion forces can be achieved with a comparatively simple production of the projections which are different on both sides of the adhesive tape.

### SUMMARY OF THE INVENTION

Description of the invention: According to the invention, the object is addressed by an adhesive tape in accordance with claim 1.

In the adhesive tape according to the invention, first projections protrude from the first carrier surface and second projections protrude from the second carrier surface, wherein the first projections are arranged on the first carrier surface with a first surface density and the second projections are arranged on the second carrier surface with a second surface density, wherein the first surface density and the second surface density are different from one another. The different surface densities mean that the adhesion force with which the first carrier surface acts on a mating surface (to which the adhesive tape is to be attached) is different from the adhesion force with which the second carrier surface acts on the mating surface.

The projections protrude, in particular, vertically from the corresponding carrier surface. The surface density of the projections is understood, in particular, to mean the number of projections on a surface portion of the corresponding carrier surface divided by the area of this surface portion.

According to an advantageous embodiment of the adhesive tape, the carrier has a first layer and a second layer, wherein the first layer has the first carrier surface and the second layer has the second carrier surface, wherein the layers are arranged one above the other in the direction of the sequence of the carrier surfaces. The layers with the carrier surfaces and the associated projections can first be manufactured separately and then combined to form the adhesive tape. This advantageously simplifies the manufacturing process of the adhesive tape.

The two layers can be formed integrally with each other. It is also preferable to structure the two sides one after the other. In other words, the first projections may be formed first and then the second projections may be formed.

In a further development of the design of the adhesive tape with two layers, the first layer and/or the second layer has/have a thickness of 300 μm to 400 μm. This means that the layers are stable in typical manufacturing materials, but their shape is easily adaptable.

Some projections can advantageously be designed the same or similar to the second projections, thereby simplifying the production process of the adhesive tape.

In a preferred embodiment of the adhesive tape, a predominant number of the first projections are formed identically to a predominant number of the second projections, wherein, in particular, the first projections and the second projections are all formed identically. The projections have the same features on both sides of the adhesive tape, which reduces the effort required to manufacture the adhesive tape.

An embodiment of the adhesive tape in which the carrier has a thickness of 600 μm to 5000 μm is advantageous. At this thickness, the carrier is stable with typical manufacturing materials, but its shape is easily adjustable. The thickness of the carrier is preferably 800 μm to 1000 μm.

An embodiment of the adhesive tape is preferred in which the carrier has a further layer, which is, in particular, designed as a film. The further layer gives the adhesive tape additional stability. In particular, the first and second layers can be formed with a comparatively low thickness while maintaining their functionality. The further layer is particularly flexible. The further layer has, in particular, a layer thickness of 60 μm or less, particularly preferably of 40 μm or less. The thickness of the further layer is preferably 5 μm or more, particularly preferably 10 μm or more.

In a further development of the aforementioned embodiment, the further layer comprises a textile, a nonwoven, a mesh, polyurethane (PUR), polyethylene terephthalate (PET) and/or foam, in particular, acrylate foam, as material. In such materials, the further layer is flexible and stable.

An embodiment of the adhesive tape is advantageous in which the first projections and/or the second projections have a height of 40 μm to 70 μm, in particular, a height of 50 μm to 60 μm. This allows the projections to adapt to unevenness of the mating surface while remaining elastic for typical manufacturing materials and typical diameters.

In a preferred embodiment of the adhesive tape, the first projections are arranged with a surface density of 25,000 projections to 50,000 projections per cm² on the first carrier surface and/or the second projections are arranged with a surface density of 15,000 projections to 20,000 projections per cm² on the second carrier surface. Such surface densities result in a strong adhesion force of the carrier surface to a typical mating surface. At the same time, the surface densities are so different that the adhesion forces caused by the carrier surfaces differ significantly.

In advantageous embodiments of the adhesive tape, the first projections and/or the second projections comprise an elastomer as material, wherein the first and/or the second projections are formed, in particular, from elastomer. This gives the projections a high degree of elasticity. The elastomer is preferably in the form of polyurethane, thermoplastic elastomer or polysiloxane, in particular, polyvinylsiloxane. In the case of a polysiloxane, this can be crosslinked, in particular, by heat, UV light and/or a Pt catalyst.

Furthermore, an embodiment of the adhesive tape is preferred in which the first projections and/or the second projections have a maximum width of 30 μm-100 μm. Such a comparatively thin design of the projections increases their elasticity to adapt to the shape of a typical (uneven) mating surface.

An embodiment of the adhesive tape is advantageous in which each projection has a shaft which protrudes from the associated carrier surface, wherein head portions are formed at the distal ends of the shafts which have a greater width than the width of the shafts. As a result, the projections are easily deformable but have a large adhesive surface on the corresponding head portion. The distal ends are, in particular, the ends of the shafts that face away from the carrier surface.

The corresponding projection is preferably rotationally symmetrical. Within the context of the application, rotational symmetry of a body is understood, in particular, to mean that the body, in particular, the projection, is imaged onto itself when rotated about an axis of symmetry of the body by an angle of greater than 0° and less than 360°. The projection preferably has a portion that is in the form of a rotationally symmetrical half of a hyperboloid. The projection is preferably in the form of a hyperboloid. In preferred embodiments, the projection has a portion in the form of a rotationally symmetrical first half of a hyperboloid, which first half widens in the direction from the center of the projection to the end of the projection at the carrier surface, and a portion in the form of a rotationally symmetrical second half of a hyperboloid, which second half widens in the direction from the center of the projection to the head portion. The second hyperboloid half preferably has curvatures, in particular, local curvatures, which are greater than the curvatures, in particular, the local curvatures, of the first hyperboloid half.

In particular, the end of the corresponding projection at the carrier surface has a greater width than the head portion of the projection. The projection preferably has the smallest width in a portion that extends from the center of the projection to the head portion. In particular, the width is measured perpendicularly to a longitudinal axis of the projection.

The head portion, in plan view of the corresponding projection, preferably has the shape of a circle or a regular polygon, in particular, a regular hexagon. The head portion preferably has an end surface and a lateral surface which adjoins the end surface. In particular, an angle of greater than 0° and less than 180° is formed between the end surface and the lateral surface along a common boundary curve of the two surfaces, in particular locally. The end surface preferably has a different, in particular, local, curvature than the lateral surface of the head portion. In particular, a lateral surface is understood to mean a side surface of the projection that has a normal vector that is perpendicular to a longitudinal axis through the projection.

An embodiment of the adhesive tape is preferred in which the first projections and/or the second projections are formed integrally with the carrier. This simplifies the manufacturing process of the adhesive tape. In addition, the projections are stably fixed (with a material bond) to the carrier surfaces.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1 schematically shows a longitudinal section through a first embodiment of an adhesive tape;

FIG. 2 schematically shows an enlarged detail of the longitudinal section through the adhesive tape; and

FIG. 3 schematically shows a longitudinal section through a second embodiment of an adhesive tape.

### DETAILED DESCRIPTION OF EMBODIMENTS OF THE INVENTION

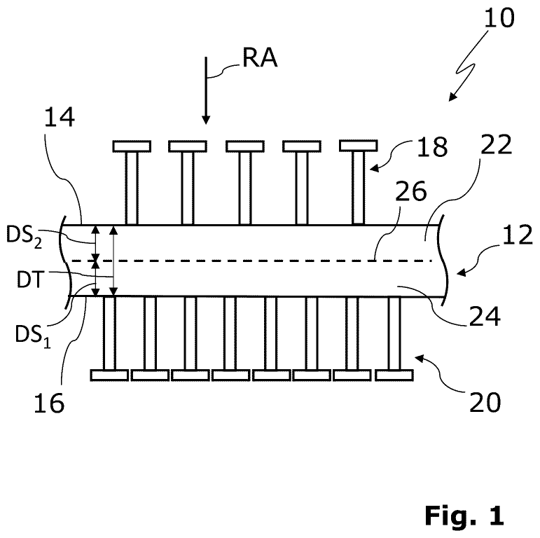

FIG. 1 shows schematically a longitudinal section through a first embodiment of an adhesive tape 10 according to the invention. A carrier 12 of the adhesive tape 10 has a first carrier surface 14 and a second carrier surface 16 wherein the second carrier surface 16 is formed on the carrier 12 opposite the first carrier surface 14. From the first carrier surface 14, first projections 18 protrude vertically. From the second carrier surface 16, second projections 20 protrude vertically. In this case, a first surface density with which the first projections 18 are arranged on the first carrier surface 14 is lower than a second surface density with which the second projections 20 are arranged on the second carrier surface 16.

The carrier 12 is divided into a first layer 22 and a second layer 24 with a thickness DS₁, DS₂, respectively, with a dividing surface 26 between the layers 22, 24 indicated by dashed lines to illustrate that the layers 24, 26 could also be present in the form of a single layer. The first carrier surface 14 belongs to the first layer 22 and the second carrier surface 16 belongs to the second layer 24. The second layer 24 is arranged on the first layer 22 in a direction RA of the sequence of carrier surfaces 14, 16. The thickness DT of the carrier 12 is the sum of the thicknesses of the layers DS₁, DS₂.

As an alternative to the layer structure, the carrier 12 can be formed in one piece according to the invention.

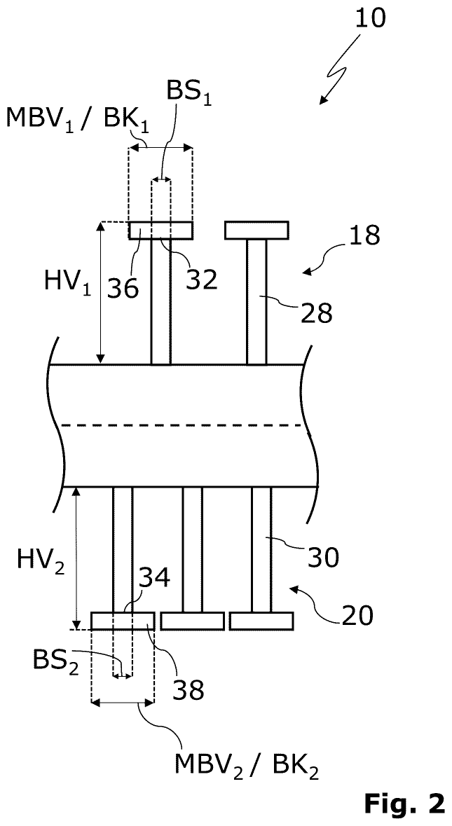

FIG. 2 shows schematically an enlarged detail through the longitudinal section through the adhesive tape 10 according to FIG. 1. The first projections 18 and the second projections 20 are each in the form of a cylindrical or hyperboloidal shaft 28, 30, with the distal ends 32, 34 (remote from the carrier surface 14, 16) of the shafts each having a head portion 36, 38 of the projections 18, 20. The projections 18, 20 have a height HV₁, HV₂. The shafts 28, 30 have a width BS₁, BS₂ (here in the form of a diameter), wherein the widths BS₁, BS₂ of the shafts 28, 30 are less than a width BK₁, BK₂ (here the diameter) of the head portions 36, 38. In the embodiment shown, the width BK₁, BK₂ of the head portions 36, 38 is simultaneously the maximum width MBV₁, MBV₂ of the corresponding projection 18, 20. The projections 18, 20 have, in particular, identical features.

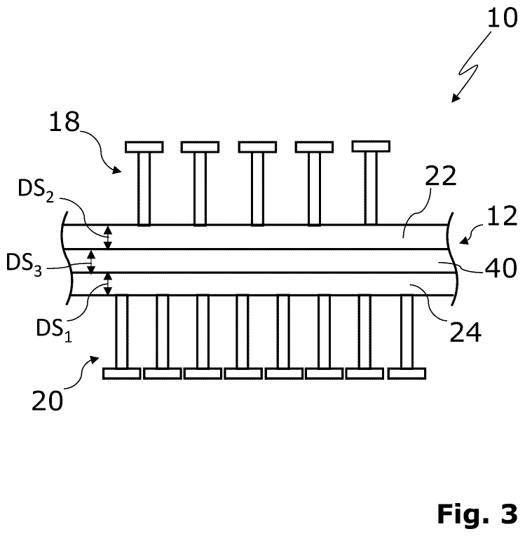

FIG. 3 shows a second embodiment of the adhesive tape 10 with the first layer 22 and the second layer 24 as well as the first projections 18 and second projections 20. In contrast to the first embodiment, the adhesive tape in the embodiment shown in FIG. 3 has a further layer 40 which is arranged between the first layer 22 and the second layer 24. The further layer 40 is particularly flexible, preferably designed as a film. Preferably, the further layer 40 comprises a material made of a textile, a nonwoven, a mesh, polyurethane (PUR), polyethylene terephthalate (PET) and/or foam, in particular, acrylate foam. The further layer 40 increases the stability of the adhesive tape 10. In particular, while maintaining its functionality, the first layer 22 could be designed with a lower layer thickness DS2₁ and the second layer 24 could be designed with a lower layer thickness DS2₂ than in the first embodiment. The thickness DS2₃ of the further layer is, in particular, 60 μm or less, preferably 40 μm or less. Preferably the thickness DS2₃ of the further layer is 5 μm or more, particularly preferably 10 μm or more.

An overview of all the figures of the drawings reveals that the invention relates in summary to an adhesive tape 10 with a carrier 12 and first and second projections 18, 20, each of which is directly connected to the carrier 12 at one end. The projections 18, 20 are located on opposite carrier surfaces 14, 16 on the surface of the carrier 12. A first surface density with which the first projections 18 are distributed on the first carrier surface 14 is different from a second surface density with which the second projections 20 are distributed on the second carrier surface 16. A further layer 40 can be provided between layers 22, 24 of the carrier 12 in order to be able to make the layers 22, 24 thinner while still maintaining high stability.

### LIST OF REFERENCE SIGNS

10 adhesive tape
12 carrier
14 first carrier surface
16 second carrier surface
18 first projections
20 second projections
22 first layer
24 second layer
26 dividing surface
28 cylindrical or hyperboloidal shafts of the first projections
30 cylindrical or hyperboloidal shafts of the second projections
32 distal ends at the first projections
34 distal ends at the second projections
36 head portions of the first projections
38 head portions of the second projections
40 further layer
DS₁ thickness of the first layer
DS₂ thickness of the second layer
DT thickness of the carrier
RA direction of the sequence of carrier surfaces
HV₁ height of the first projections
HV₂ height of the second projections
BS₁ width of the shafts of the first projections
BS₂ width of the shafts of the second projections
BK₁ width of the head portions of the first projections
BK₂ width of the head portions of the second projections
MBV₁ maximum width of the first projections
MBV₂ maximum width of the second projections

What is claimed is:

1. An adhesive tape comprises:
a carrier the surface of which is formed with a first carrier surface and a second carrier surface, wherein the carrier surfaces are opposite one another;
wherein first projections protrude from the first carrier surface and second projections protrude from the second carrier surface;
wherein the first projections are arranged on the first carrier surface with a first surface density and the second projections are arranged on the second carrier surface with a second surface density; and
wherein the first surface density and the second surface density are different from each other.

2. The adhesive tape according to claim 1, wherein the carrier comprises a first layer and a second layer, wherein the first layer comprises the first carrier surface and the second layer comprises the second carrier surface, wherein the layers are arranged one above the other in the direction (RA) of the sequence of the carrier surfaces.

3. The adhesive tape according to claim 2, wherein the first layer and/or the second layer has/have a thickness (DS₁, DS₂) of 300 μm to 400 μm.

4. The adhesive tape according to claim 1, wherein a predominant number of the first projections are formed identically to a predominant number of the second projections.

5. The adhesive tape according to claim 4, wherein the first projections and the second projections are all formed identically.

6. The adhesive tape according to claim 1, wherein the carrier has a thickness (DT) of 600 μm to 5000 μm.

7. The adhesive tape according to claim 1, wherein the carrier has a further layer which is designed as a film.

8. The adhesive tape according to claim 7, wherein the further layer comprises a textile, a nonwoven, a mesh, polyurethane (PUR), polyethylene terephthalate (PET) and/or foam, being acrylate foam, as material.

9. The adhesive tape according to claim 1, wherein the first projections and/or the second projections have a height (HV₁, HV₂) of 40 μm to 70 μm.

10. The adhesive tape according to claim 1, wherein the first projections and/or the second projections have a height (HV₁, HV₂) of 50 μm to 60 μm.

11. The adhesive tape according to claim 1, wherein the first projections are arranged with a surface density of 25,000 projections to 50,000 projections per cm² on the first carrier surface and/or the second projections are arranged with a surface density of 15,000 projections to 20,000 projections per cm² on the second carrier surface.

12. The adhesive tape according to claim 1, wherein the first projections and/or the second projections comprise an elastomer as material and are formed from the elastomer.

13. The adhesive tape according to claim 1, wherein the first projections and/or the second projections have a maximum width (MBV₁, MBV₂) of 30 μm-100 μm.

14. The adhesive tape according to claim 1, wherein each projection has a shaft projecting from the associated carrier surface, wherein head portions are formed at the distal ends of the shafts and have a greater width (BK₁, BK₂) than the width (BS₁, BS₂) of the shafts.

15. The adhesive tape according to claim 1, wherein the first projections and/or the second projections are formed integrally with the carrier.
